(19) United States
(12) Patent Application Publication
(10) Pub. No.: US 2018/0152860 A1
(43) Pub. Date: May 31, 2018

(54) BUFFER STATUS REPORT TRIGGERING

(71) Applicant: QUALCOMM Incorporated, San Diego, CA (US)

(72) Inventors: Xiaolong Huang, San Jose, CA (US); Srinivas Katar, Fremont, CA (US); Chao Zou, Milpitas, CA (US)

(21) Appl. No.: 15/361,982

(22) Filed: Nov. 28, 2016

(51) Int. Cl. H04W 28/02; H04W 72/04; H04L 5/00; H04L 29/06; H04L 12/26

(52) U.S. Cl. CPC H04W 28/0278; H04W 72/0413; H04L 43/16; H04L 5/0055; H04L 69/163; H04W 72/0446

(57) ABSTRACT

Methods, systems, and devices for wireless communication are described for buffer status report triggering. An access point (AP) may identify that an amount of uplink data queued in a buffer of a station is less than a predetermined threshold. The AP may determine that a buffer status report (BSR) trigger condition is satisfied by estimating that the station has data to transmit to the access point, or by identifying that the access point will schedule an uplink transmission for the station. The AP may transmit a BSR trigger to the station based at least in part on identifying that the amount of uplink data queued in the buffer is less than the predetermined threshold and determining that the BSR trigger condition is satisfied.

### BACKGROUND

The present disclosure relates generally to wireless communication, and more specifically to buffer status report triggering.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL) transmissions. The DL (or forward link) may refer to the communication link from the AP to the STA, and the UL (or reverse link) may refer to the communication link from the STA to the AP.

Wireless communications systems may seek to improve average throughput per STA in dense environments that include many STAs. An AP may allocate resources to one or more STAs served by the AP, the resources assigned in resource units (RUs), where each RU may be assigned to one or more STAs. A scheduler of the AP may decide which STA (or group of STAs) and which transmit identifier (TID) may be assigned to an RU for an uplink transmission during a particular time. The scheduler may use information concerning the transmission needs of the STAs when allocating RUs. Conventional scheduling techniques, however, are inefficient and may use excessive overhead to obtain information about the transmission needs of the one or more STAs.

### SUMMARY

The described techniques relate to improved methods, systems, devices, or apparatuses that support buffer status report triggering. Techniques are described for triggering a station (STA) to report its buffer status to an access point (AP). In a wireless local area network (WLAN), an AP may allocate uplink (UL) resources to multiple STAs that share a communication medium. For efficient allocation of the limited UL resources, the AP may prompt STAs that it serves to send a buffer status report (BSR). The examples described herein provide techniques for triggering a station to report its BSR, including by estimating that a STA has data to transmit, or identifying that a STA is due to be scheduled, or both. In an example, an AP may identify that an amount of uplink data queued in a buffer of a STA is less than a predetermined threshold. The AP may also determine that a BSR trigger condition is satisfied by estimating that the STA has data to transmit to the AP, or by identifying that the AP will schedule an uplink transmission for the STA. The AP may then transmit a BSR trigger to the STA based at least in part on identifying that the amount of uplink data queued in the buffer is less than the predetermined threshold and determining that the BSR trigger condition is satisfied.

A method of wireless communication is described. The method may include identifying that an amount of uplink data queued in a buffer of a station is less than a predetermined threshold, determining that a BSR trigger condition is satisfied by estimating that the station has data to transmit to the access point, or by identifying that the access point will schedule an uplink transmission for the station, and transmitting a BSR trigger to the station based at least in part on identifying that the amount of uplink data queued in the buffer is less than the predetermined threshold and determining that the BSR trigger condition is satisfied.

An apparatus for wireless communication is described. The apparatus may include means for identifying that an amount of uplink data queued in a buffer of a station is less than a predetermined threshold, means for determining that a BSR trigger condition is satisfied by estimating that the station has data to transmit to the access point, or by identifying that the access point will schedule an uplink transmission for the station, and means for transmitting a BSR trigger to the station based at least in part on identifying that the amount of uplink data queued in the buffer is less than the predetermined threshold and determining that the BSR trigger condition is satisfied.

Another apparatus for wireless communication is described. The apparatus may include a processor, memory in electronic communication with the processor, and instructions stored in the memory. The instructions may be operable to cause the processor to identify that an amount of uplink data queued in a buffer of a station is less than a predetermined threshold, determine that a BSR trigger condition is satisfied by estimating that the station has data to transmit to the access point, or by identifying that the access point will schedule an uplink transmission for the station, and transmit a BSR trigger to the station based at least in part on identifying that the amount of uplink data queued in the buffer is less than the predetermined threshold and determining that the BSR trigger condition is satisfied.

A non-transitory computer readable medium for wireless communication is described. The non-transitory computer-readable medium may include instructions operable to cause a processor to identify that an amount of uplink data queued in a buffer of a station is less than a predetermined threshold, determine that a BSR trigger condition is satisfied by estimating that the station has data to transmit to the access point, or by identifying that the access point will schedule an uplink transmission for the station, and transmit a BSR trigger to the station based at least in part on identifying that the amount of uplink data queued in the buffer is less than the predetermined threshold and determining that the BSR trigger condition is satisfied.

In some examples of the method, apparatus, and non-transitory computer-readable medium described above, estimating that the station may have data to transmit to the access point comprises: determining a traffic pattern for the station. Some examples of the method, apparatus, and non-transitory computer-readable medium described above may further include processes, features, means, or instructions for estimating that the station may have data to transmit to the access point based at least in part on the determined traffic pattern.

In some examples of the method, apparatus, and non-transitory computer-readable medium described above, identifying that the access point will schedule the uplink transmission for the station comprises: determining a statistical metric of historical scheduling intervals for the station.

Some examples of the method, apparatus, and non-transitory computer-readable medium described above may further include processes, features, means, or instructions for identifying a time when the access point will schedule an uplink transmission for the station, wherein the BSR trigger may be transmitted to the station within a predefined time period prior to the identified time.

Some examples of the method, apparatus, and non-transitory computer-readable medium described above may further include processes, features, means, or instructions for determining that the station lacks data to transmit based at least in part on a BSR received from the station. Some examples of the method, apparatus, and non-transitory computer-readable medium described above may further include processes, features, means, or instructions for adding an amount of time to a BSR trigger interval for the station based at least in part on determining that the station lacks data to transmit.

In some examples of the method, apparatus, and non-transitory computer-readable medium described above, adding the amount of time to the BSR trigger interval comprises: adding the amount of time to the BSR trigger interval for each BSR received from the station indicating that the station lacks data to transmit until a maximum BSR trigger interval value may be reached.

Some examples of the method, apparatus, and non-transitory computer-readable medium described above may further include processes, features, means, or instructions for estimating that the station may have data to transmit to the access point may be based at least in part on: a type of data traffic identified in a traffic pattern of the station, or a minimum throughput requirement associated with data traffic identified in the traffic pattern, or a delay requirement associated with data traffic identified in the traffic pattern, or a combination thereof.

In some examples of the method, apparatus, and non-transitory computer-readable medium described above, estimating that the station may have data to transmit to the access point comprises: determining that a predefined amount of transmission control protocol (TCP) data may have been transmitted to the station. Some examples of the method, apparatus, and non-transitory computer-readable medium described above may further include processes, features, means, or instructions for determining that an amount of TCP acknowledgments (ACKs) received from the station may be below a TCP ACK ratio.

In some examples of the method, apparatus, and non-transitory computer-readable medium described above, estimating that the station may have data to transmit to the access point comprises: determining that a predefined amount of transmission control protocol (TCP) acknowledgments (ACKs) may have been transmitted to the station. Some examples of the method, apparatus, and non-transitory computer-readable medium described above may further include processes, features, means, or instructions for determining that an amount of TCP ACKs transmitted to the station may have reached a TCP ACK ratio.

In some examples of the method, apparatus, and non-transitory computer-readable medium described above, estimating that the station may have data to transmit to the access point comprises: determining that a traffic pattern satisfies a sporadic traffic metric.

In some examples of the method, apparatus, and non-transitory computer-readable medium described above, identifying that the access point will schedule the uplink transmission for the station comprises: identifying a total number of stations to be scheduled. Some examples of the method, apparatus, and non-transitory computer-readable medium described above may further include processes, features, means, or instructions for determining a scheduling interval for the station based at least in part on the total number. Some examples of the method, apparatus, and non-transitory computer-readable medium described above may further include processes, features, means, or instructions for determining a statistical metric of historical scheduling intervals for the station based at least in part on the determined scheduling interval.

In some examples of the method, apparatus, and non-transitory computer-readable medium described above, identifying that the access point will schedule the uplink transmission for the station comprises: identifying a quality of service associated with data traffic of the station. Some examples of the method, apparatus, and non-transitory computer-readable medium described above may further include processes, features, means, or instructions for determining a scheduling interval for the station based at least in part on the quality of service. Some examples of the method, apparatus, and non-transitory computer-readable medium described above may further include processes, features, means, or instructions for determining a statistical metric of historical scheduling intervals for the station based at least in part on the determined scheduling interval.

### BRIEF DESCRIPTION OF THE DRAWINGS

FIG. 1 illustrates an example of a system for wireless communication that supports buffer status report triggering in accordance with aspects of the present disclosure.

FIG. 2 illustrates an example of a process flow that supports buffer status report triggering in accordance with aspects of the present disclosure.

FIG. 3 illustrates an example flowchart for estimating that a station has data to transmit that supports buffer status report triggering in accordance with aspects of the present disclosure.

FIG. 4 illustrates an example flowchart for identifying that an access point will schedule an uplink transmission for a station that supports buffer status report triggering in accordance with aspects of the present disclosure.

FIG. 5 illustrates an example timeline corresponding buffer status report trigger interval adjustments that supports buffer status report triggering in accordance with aspects of the present disclosure.

FIGS. 6 through 8 show block diagrams of a device that supports buffer status report triggering in accordance with aspects of the present disclosure.

FIG. 9 illustrates a block diagram of a system including an access point that supports buffer status report triggering in accordance with aspects of the present disclosure.

FIGS. 10 through 12 illustrate methods for buffer status report triggering in accordance with aspects of the present disclosure.

### DETAILED DESCRIPTION

Techniques are disclosed for triggering a station to report its buffer status to an access point. In a wireless local area network (WLAN), an access point (AP) may allocate uplink (UL) resources to multiple stations (STAs) that share a communication medium. For efficient allocation of the limited UL resources, the AP may prompt STAs that it serves to send a buffer status report (BSR). The BSR may indicate how much data is queued in a buffer of a STA that is waiting to be transmitted to the AP. The AP may use the BSR to decide which STA and which traffic identifier (TID) to allocated to an uplink (UL) resource unit (RU) for UL data transmission.

In conventional techniques, a STA may inform an AP of its buffer status using different techniques that are deficient because they fail to provide UEs with a timely opportunity to report a buffer status. When a STA has already been allocated UL resource units (RUs), a STA may send a BSR within a header of a packet transmitted to the AP in the allocated UL RUs (e.g., within a physical layer convergence protocol (PLCP) header, a media access control (MAC) header, or the like). This first conventional technique is deficient as a situation may arise where a STA has data to transmit but is not currently allocated UL RUs, and hence has to wait to be scheduled by the AP before being able to send the BSR. This delay results in latency causing degraded performance. A second conventional technique for a STA to inform the AP of its buffer status is for the AP to send a request for a BSR to the STA and the STA to respond to the request with the BSR. This second conventional technique is deficient as the AP does not timely send requests for a BSR or may send a wasteful number of requests.

The examples described herein provide techniques for triggering a station to report its buffer status by estimating that a STA has data to transmit, identifying that the STA is due to be scheduled, or both. In an example, an AP may identify that an amount of uplink data queued in a buffer of a STA is less than a predetermined threshold. The AP may determine that a BSR trigger condition is satisfied by estimating that the STA has data to transmit to the AP, or by identifying that the AP will schedule an uplink transmission for the STA, or both. The AP may transmit a BSR trigger to the STA based at least in part on identifying that the amount of uplink data queued in the buffer is less than the predetermined threshold and determining that the BSR trigger condition is satisfied. Beneficially, the AP may timely send BSR triggers and efficiently utilize a shared communication medium by limiting when BSR triggers are sent.

Aspects of the disclosure are initially described in the context of a wireless communications system. The wireless communication system may trigger a station to report its BSR based at least in part on estimating that a STA has data to transmit, or by identifying that the AP will schedule an uplink transmission for the STA. Aspects of the disclosure are further illustrated by and described with reference to apparatus diagrams, system diagrams, and flowcharts that relate to buffer status report triggering.

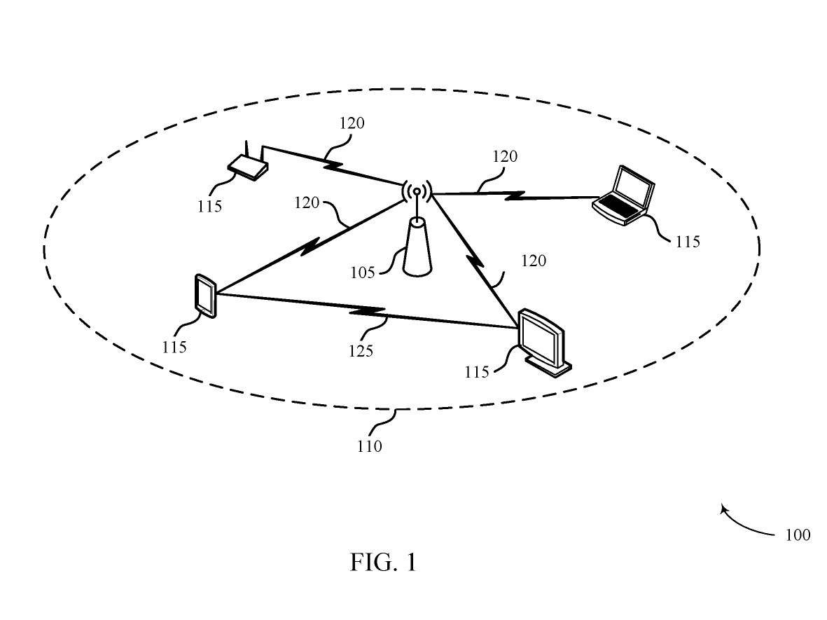

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, wireless communication terminals that include an antenna and a transceiver, phones, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS.

A STA 115 may be located in the intersection of more than one coverage area 110 and may associate with more than one AP 105. A single AP 105 and an associated set of STAs 115 may be referred to as a BSS. An ESS is a set of connected BSSs. A distribution may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

The examples described herein provide an improved mechanism for buffer status report triggering. The AP 105 may determine whether a BSR trigger condition is satisfied based at least in part on estimating that a STA 115 has data to transmit to the AP 105, or by identifying that the AP 105 will schedule an uplink transmission for the STA 115. The AP 105 may transmit a BSR trigger to the STA 115 based at least in part on identifying that the amount of uplink data queued in the buffer of the STA 115 is less than a predetermined threshold and determining that the BSR trigger condition is satisfied.

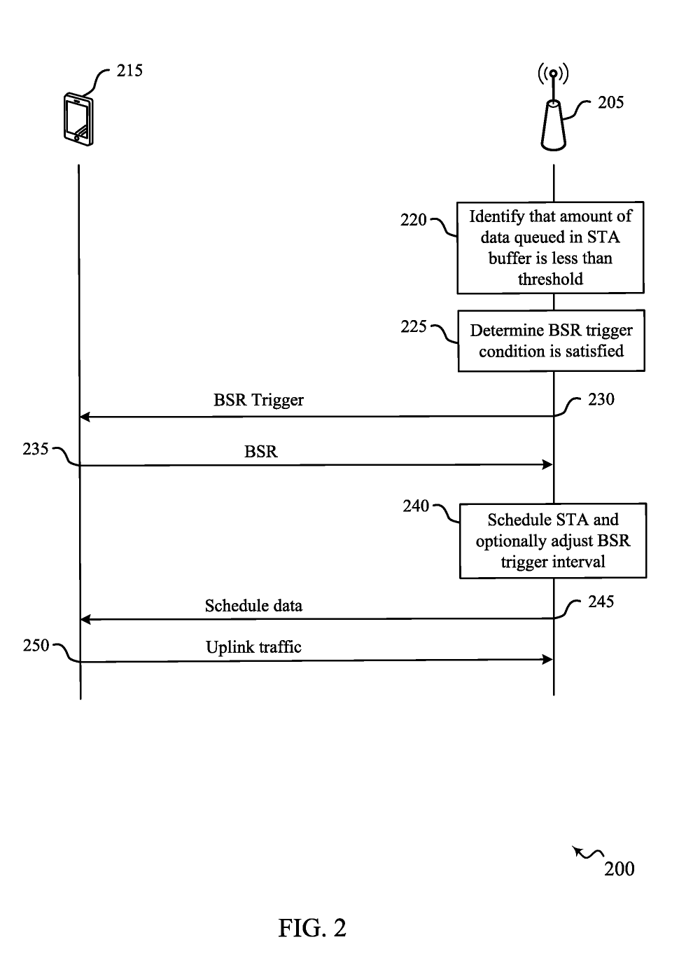

FIG. 2 illustrates an example of a process flow 200 for BSR triggering. The AP 205 may be an example of AP 105 and STA 215 may be an example of a STA 115 of FIG. 1.

At 220, the AP 205 may identify that an amount of data queued in a buffer of STA 215 is less than a predetermined threshold. The threshold may be set to a Physical Layer Convergence Protocol (PLCP) protocol data unit (PPDU) capacity in bytes of a resource unit (RU). To identify how much data is queued, the AP 205 may process a previously received BSR indicating how much data the STA 215 has to transmit and subtract the amount of data received from the STA 215. The AP 205 may compare the difference to the predetermined threshold. The predetermined threshold may be used to identify situations where the STA 215 does not currently have any allocated UL RUs (and thus may not be able to send a BSR in a header of a packet transmitted within an allocated UL RU), but STA 215 may have data to transmit.

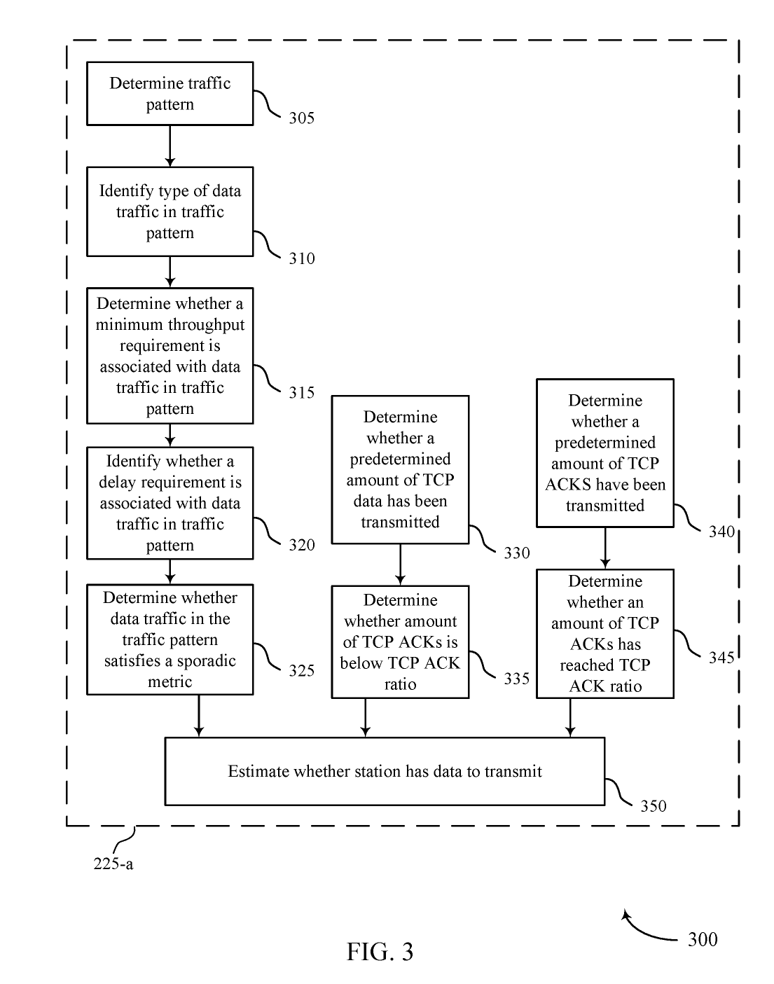

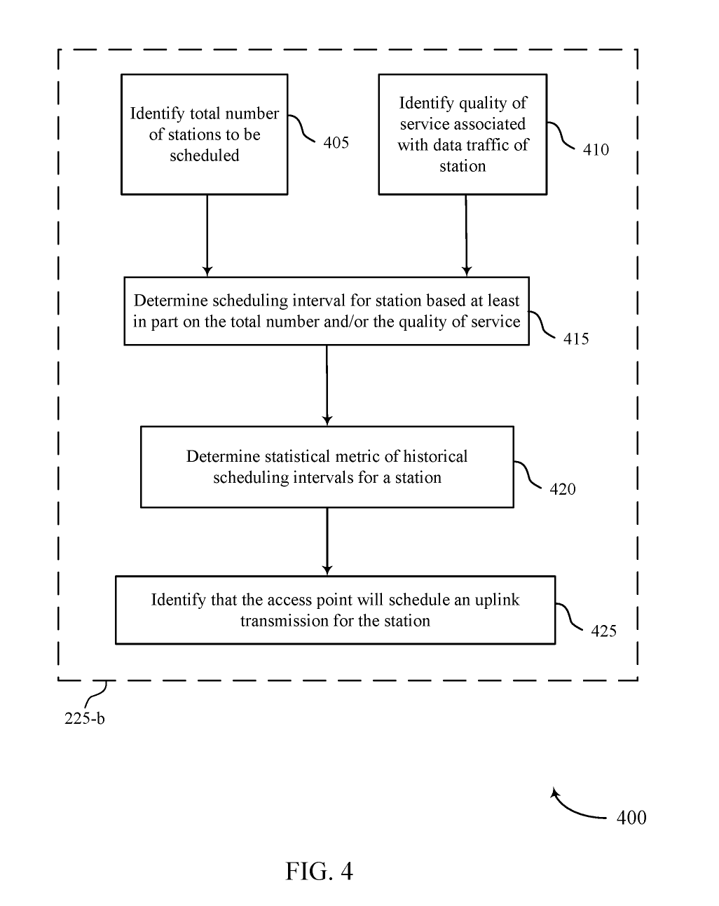

If less than the predetermined threshold, the AP 205 may, at 225, determine whether a BSR trigger condition is satisfied. In an example, a BSR trigger condition may correspond to the AP 205 estimating that the STA 215 has data to transmit to the AP 205, for example as further described below with reference to FIG. 3. In another example, a BSR trigger condition may correspond to the AP 205 identifying that it will schedule an uplink transmission for the STA 215, as further described below with reference to FIG. 4. If the BSR trigger condition is not satisfied, the AP 205 may delay or skip sending a BSR trigger, and may determine at a later time whether the BSR trigger condition is satisfied. In some examples, the AP 205 may establish a BSR trigger interval where the AP 205 occasionally or periodically determines whether the BSR trigger condition is satisfied, for example upon determining that the BSR trigger interval has expired.

If the BSR trigger condition is satisfied, the AP 205 may, at 230, send a BSR trigger to the STA 215. The STA 215 may process the BSR trigger, generate a BSR, and, at 235, send the BSR to the AP 205. The BSR may identify whether the STA 215 has data queued for transmission. If the STA 215 does not, the BSR may indicate as such. If the STA 215 does have data to transmit, the BSR may include one or more traffic identifiers (TIDs) and an amount of data queued that is associated with each TID (e.g., queue size associated with each TID).

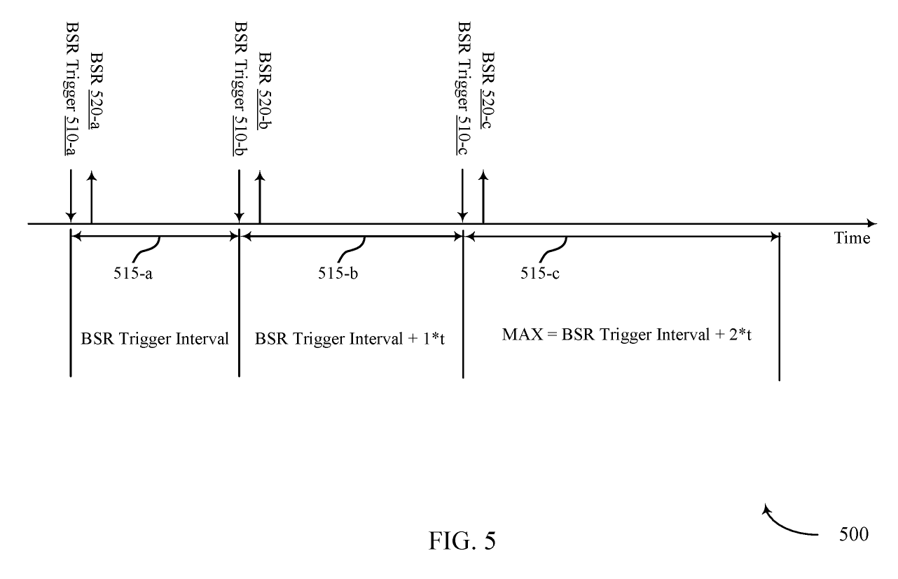

At 240, the AP 205 may process the BSR from STA 215 and determine a schedule for allocating available RUs between multiple STAs, including STA 215. The schedule may indicate the RUs each STA may use for UL transmission. The AP 205 optionally may process the BSR to adjust a BSR trigger interval, as further described below with reference to FIG. 5.

At 245, the AP 205 may send schedule data to the STA 215. The schedule data may identify one or more TIDs and inform the STA 215 of which UL RUs have been allocated for communicating data traffic corresponding to the identified TIDs. If the BSR indicated that the STA 215 does not have data to transmit, the schedule data may indicate that the AP 205 has not allocated any UL RUs to the STA 215 for transmission. In another example, if the BSR indicated that the STA 215 does not have data to transmit, the AP 205 may skip sending the schedule data to the STA 215.

At 250, the STA 215 may communicate data traffic within the allocated UL RUs to the AP 205. The process flow 200 may return to block 220, and all or portions of process flow may repeat one or more times. The AP 205 may also perform the operations in process flow 200 with multiple STAs for allocating UL RUs between the STAs.

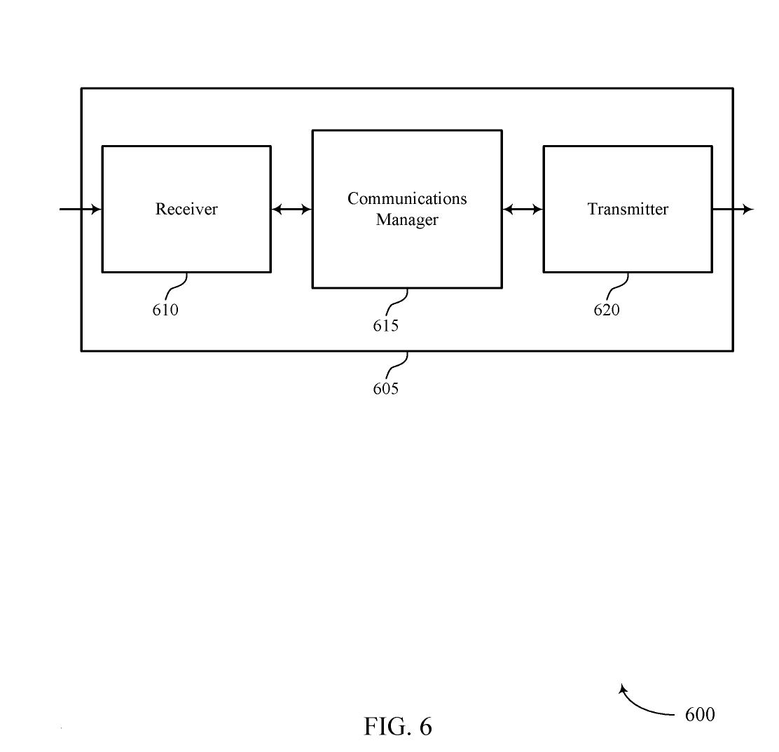

FIG. 3 illustrates an example flowchart 300 for estimating that a STA has data to transmit for buffer status report triggering. The operations of flowchart 300 may be implemented by an AP 105 or its components as described herein. For example, the operations of flowchart 300 may be performed by a communications manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

The operations 225-a described with reference to one or more of blocks 305 through 350 may correspond to functionality performed by AP 205 at 225 of FIG. 2, for example as some or all of determining whether a BSR trigger condition is satisfied based at least in part on estimating whether STA 215 has data to transmit. One or more of the operations in blocks 305 through 350 may be performed, and some blocks may be skipped. In blocks 305 through 325, the AP 205 may analyze a traffic pattern of data communicated with the STA 215. In blocks, 330 through 345, the AP 205 may monitor UL and DL transmission control protocol (TCP) traffic relative to TCP ACK ratios. In block 350, the AP 205 may estimate whether STA 215 has data to transmit based at least in part on operations performed in one or more of blocks 305 through 345.

In block 305, the AP 205 may determine a traffic pattern for STA 215. The traffic pattern may correspond to a historical record of data traffic that the STA 215 is currently exchanging and/or has previously exchanged with the AP 205. The traffic pattern may identify a total amount of data traffic exchanged, types of traffic exchanged, quality of service assigned to each traffic type, how frequently the data traffic is exchanged, or the like.

In block 310, the AP 205 may identify a type of data traffic in the traffic pattern for STA 215. In an example, types of data traffic include real-time traffic (e.g., voice, video, etc.), and non-real-time traffic (e.g., web browsing, email, etc.). Real-time traffic may be sensitive to delay, whereas a user may tolerate a certain amount of latency in non-real-time traffic. Types of data may also be assigned a priority level (e.g., high priority, medium priority, low priority, etc.). The priority level may be used to determine the order in which data is sent, with high priority being sent before medium priority, and medium priority being sent before low priority, and so on.

In block 315, the AP 205 may identify whether a minimum throughput requirement is associated with data traffic identified in the traffic pattern. In an example, real-time traffic may have a minimum throughput requirement to provide a satisfactory user experience (e.g., so that video is not choppy). The minimum throughput requirement may specify that at least a predetermined amount of data is communicated per time unit (e.g., at least 10 megabits per second).

In block 320, the AP 205 may identify whether a delay requirement is associated with data traffic in the traffic pattern. In an example, real-time traffic may have a delay requirement to provide a satisfactory user experience. The delay requirement may specify that data is required to be transmitted with a latency that is less than or equal to a defined amount of delay.

In block 325, the AP 205 may determine whether data traffic in the traffic pattern satisfies a sporadic traffic metric. In some instances, a STA 215 may only sporadically have UL data to transmit. The sporadic traffic metric may be used to at least occasionally or periodically give such a STA 215 the opportunity to transmit a BSR. The AP 205 may determine that the sporadic traffic metric is satisfied, for example, if the traffic pattern indicates that the STA 215 has previously transmitted UL data, and the AP 205 has not sent a BSR trigger to the STA 215 within a predetermined amount of time. If a BSR received from the STA 215 in response to the BSR trigger indicates no UL data to transmit, the AP 205 may use OFDMA backoff to lengthen the amount of time before subsequently determining whether data traffic in the traffic pattern satisfies the sporadic traffic metric. The OFDMA backoff may be used for channel efficiency reasons to prevent giving a STA 215 that transmits sporadically too many opportunities to send a BSR.

Blocks 330 through 345 may correspond to when the AP 205 and STA 215 are exchanging TCP traffic. Blocks 330 through 335 may relate to DL TCP traffic being communicated from the AP 205 to the STA 215, and blocks 340 through 345 may relate to UL TCP traffic being communicated from the STA 215 to the AP 205.

In block 330, the AP 205 may determine whether a predefined amount of DL TCP data has been transmitted to the STA 215. In block 335, the AP 205 may determine whether an amount of TCP acknowledgments (ACKs) received from the STA 215 is below a TCP acknowledgement (ACK) ratio. The STA 215 may send a TCP ACK to acknowledge TCP data received from AP 205 after a predetermined number of bytes are received by STA 215, based on the TCP ACK ratio. The AP 205 may use the TCP ACK ratio to determine when to allocate UL RUs to the STA 215 to enable it to send a TCP ACK when the ratio has been met. In some instances, the AP 205 may have transmitted all of the TCP data it has to send to the STA 215 but not enough TCP data was sent to satisfy the TCP ACK ratio at the STA 215. In such a scenario, the STA 215 may not have acknowledged whether the last of the TCP data has been successfully received and decoded. Thus, the STA 215 may have a TCP ACK to send but has not yet been allocated an UL RU for sending the TCP ACK because the TCP ACK ratio has not been met.

Blocks 340 through 345 correspond to a complementary scenario as described with reference to blocks 330 through 335. In block 340, the AP 205 may determine whether a predefined amount of TCP ACKs have been transmitted to the STA 215. In block 345, the AP 205 may determine whether an amount of TCP ACKs transmitted to the STA 215 has reached a TCP ACK ratio. The AP 205 may use the TCP ACK ratio to determine when to allocate UL RUs to the STA 215 to enable it to send TCP data when the TCP ACK ratio has been met. In blocks 340 through 345, the STA 215 may have transmitted sufficient TCP data to satisfy the TCP ACK ratio but has not transmitted all of the TCP data that STA 215 has to send to the AP 205.

In block 350, the AP 205 may estimate whether the STA 215 has data to transmit based at least in part on one or more different criteria. AP 205 may determine that the data traffic in the traffic pattern satisfies the sporadic traffic metric. In another example, AP 205 may determine that the AP 205 has transmitted all of the TCP data it has to send to the STA 215, but not enough TCP data was sent to satisfy the TCP ACK ratio. In some examples, AP 205 may determine that a STA 215 may have transmitted enough TCP data to satisfy the TCP ACK ratio, but that STA 215 has not transmitted all of the TCP data it has to send to the AP 205. In yet another example, the AP 205 may estimate that STA 215 has data to transmit based on a type of data identified by AP 205 in a traffic pattern of STA 215, a minimum throughput requirement associated with data traffic identified in the traffic pattern of STA 215, a delay requirement for the traffic pattern, or any other combination thereof. If the AP 205 estimates that the STA 215 does not have data to transmit, the AP 205 may not send the BSR trigger. On the other hand, AP 205 may send the BSR trigger if it estimates that the STA 215 does have data to transmit.

FIG. 4 illustrates an example flowchart 400 for identifying that an AP will schedule an uplink transmission for a STA for buffer status report triggering. The operations of flowchart 400 may be implemented by an AP 105 or its components as described herein. For example, the operations of flowchart 400 may be performed by a communications manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

The depicted operations 225-b in blocks 405 through 425 may correspond to functionality performed at block 225 for determining whether a BSR trigger condition is satisfied based at least in part on identifying that AP 205 will schedule an uplink transmission for STA 215. One or more of the operations in blocks 405 through 425 may be performed, and some blocks may be skipped. In blocks 405 through 415, the AP 205 may determine a scheduling interval for STA 215 based at least in part on a total number of stations to be scheduled. In blocks, 420 through 425, the AP 205 may determine a scheduling interval for STA 215 based at least in part on a quality of service associated with data traffic of STA 215.

In block 405, the AP 205 may identify a total number of stations to be scheduled. The total number of stations may be the number of STAs that are currently associated with the AP 205. In block 410, the AP 205 may identify a quality of service associated with data traffic of STA 215. Examples of quality of service include constant bit rate, real-time variable bit rate, non-real-time variable bit rate, and best effort.

In block 415, the AP 205 may determine a scheduling interval for STA 215 based at least in part on the total number and/or the quality of service. In an example, the AP 205 may give the STAs equal opportunity to use the shared communication medium, and hence may use round robin scheduling for the STAs 215 (e.g., ten STAs are each given one scheduling opportunity of the next ten scheduling opportunities). In another example, the AP 205 may give the STAs unequal opportunity to use the shared communication medium based at least in part on the quality of service of data traffic being used by the STAs. The AP 205 may select a scheduling interval to meet the quality of service of the data traffic.

In block 420, the AP 205 may determine a statistical metric of historical scheduling intervals for STA 215 based at least in part on the determined scheduling interval. In an example, the AP 205 may determine an average of the scheduling intervals for STA 215. The average may be limited to a set of the most recent scheduling intervals (e.g., the ten most recent scheduling intervals).

In block 425, the AP 205 may identify that it will schedule an uplink transmission for STA 215 based at least in part on the determined statistical metric of historical scheduling intervals for STA 215. For example, the AP 205 may utilize the statistical metric to identify a time when the AP 205 will schedule an uplink transmission for the STA 215. If the BSR condition is satisfied, the AP 205 may send the BSR trigger to the STA 215 within a predefined time period prior to the identified time. If not due to schedule the STA 215 within a threshold amount of time (e.g., within a next 50 milliseconds), the AP 205 may delay communicating the BSR trigger until within the threshold amount of time of when the STA 215 is to be scheduled.

FIG. 5 illustrates an example timeline 500 corresponding to BSR trigger interval adjustments for buffer status report triggering. Referring to FIG. 2, the AP 205 may, at block 240, optionally adjust a BSR trigger interval based at least in part on a BSR received from the STA 215. In timeline 500, the AP 205 may send a BSR trigger 510 when a BSR trigger interval expires and a BSR condition is satisfied. The STA 215 may respond to the BSR trigger 510 with a BSR 520.

Each time the BSR 520 indicates that the STA 215 does not have data to transmit, the AP 205 may lengthen the BSR trigger interval. As illustrated in timeline 500, the AP 205 may send BSR trigger 510-a and the STA 215 may reply with BSR 520-a indicating that STA 215 has data to transmit. After BSR trigger interval 515-a expires, the AP 205 may send BSR trigger 510-b and the STA 215 may reply with BSR 520-b indicating that STA 215 has no data to transmit. The AP 205 may then lengthen the next BSR trigger interval 515-b (e.g., BSR Trigger Interval +1*t). After BSR trigger interval 515-b expires, the AP 205 may send BSR trigger 510-c and the STA 215 may reply with BSR 520-c indicating that STA 215 has no data to transmit. The AP 205 may then lengthen the next BSR trigger interval 515-c (e.g., BSR Trigger Interval +2*t). The amount of time added to the BSR trigger interval 515 may be a fixed amount or may depend on current traffic congestion levels. In some examples, the amount of time added may gradually increase the BSR trigger interval 515. The AP 205 may lengthen the BSR trigger interval 515 until it reaches a maximum value. In some instances, the maximum may depend on traffic type with the maximum being lower for delay sensitive traffic, high priority traffic, and the like. The AP 205 may also shorten the BSR trigger interval 515. For example, after the BSR trigger interval 515 has been lengthened one or more times, the AP 205 may remove some or all of the added amount of time of BSR trigger interval 515 the next time a BSR 520 indicates that the STA 215 has data to transmit. For example, the AP 205 may remove one of the fixed amounts for each BSR 520 indicating that the STA 215 has data to transmit.

Beneficially, the techniques described herein may trigger a station to report its BSR by estimating that a STA has data to transmit, identifying that the STA is due to be scheduled, or both. Conventional techniques are deficient for failing to timely provide a STA with an opportunity to send a BSR that is not currently allocated UL RUs, and for failing to send a BSR trigger when the STA will be scheduled by the AP or is estimated to have data to transmit.

FIG. 6 shows a block diagram 600 of a wireless device 605 that supports buffer status report triggering in accordance with various aspects of the present disclosure. Wireless device 605 may be an example of aspects of an AP 105 as described with reference to FIG. 1. Wireless device 605 may include receiver 610, communications manager 615, and transmitter 620. Wireless device 605 may also include a processor and memory. Each of these components may be in communication with one another (e.g., via one or more buses).

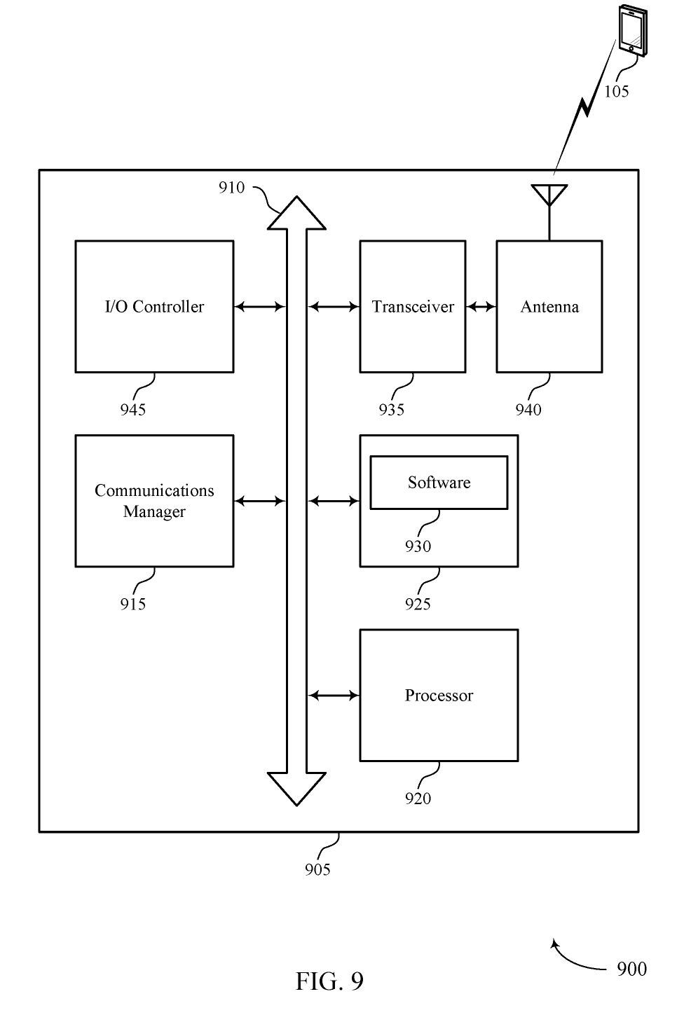

Receiver 610 may receive information such as packets, user data, or control information associated with various information channels (e.g., control channels, data channels, and information related to buffer status report triggering, etc.). Information may be passed on to other components of the device. The receiver 610 may be an example of aspects of the transceiver 935 described with reference to FIG. 9.

Communications manager 615 may be an example of aspects of the communications manager 915 described with reference to FIG. 9. Communications manager 615 may identify that an amount of uplink data queued in a buffer of a station is less than a predetermined threshold, determine that a BSR trigger condition is satisfied by estimating that the station has data to transmit to the access point, or by identifying that the access point will schedule an uplink transmission for the station, and transmit a BSR trigger to the station based at least in part on identifying that the amount of uplink data queued in the buffer is less than the predetermined threshold and determining that the BSR trigger condition is satisfied.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may include a single antenna, or it may include a set of antennas.

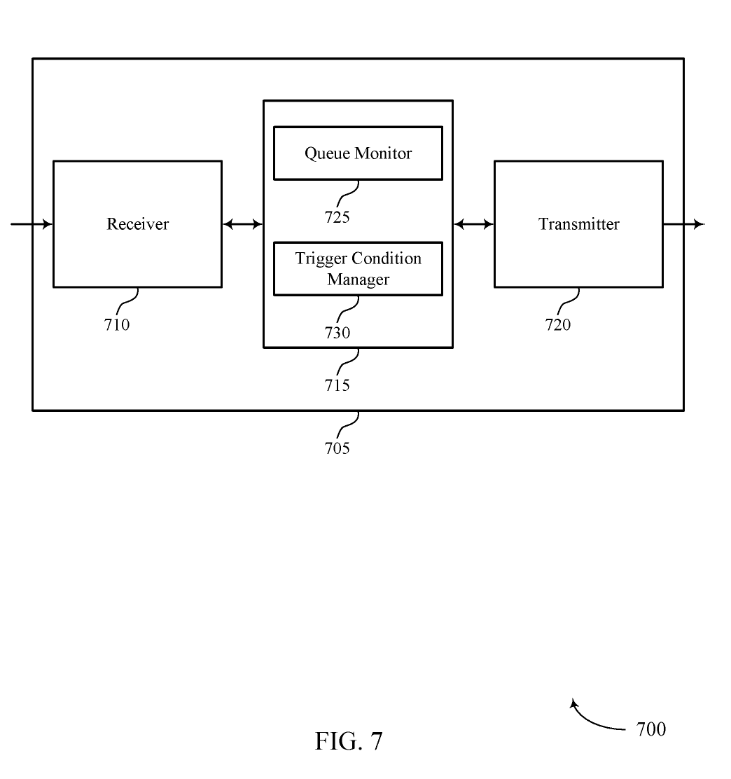

FIG. 7 shows a block diagram 700 of a wireless device 705 that supports buffer status report triggering in accordance with various aspects of the present disclosure. Wireless device 705 may be an example of aspects of a wireless device 605 or an AP 105 as described with reference to FIGS. 1 and 6. Wireless device 705 may include receiver 710, communications manager 715, and transmitter 720. Wireless device 705 may also include one or more processors, memory coupled with the one or more processors, and instructions stored in the memory that are executable by the one or more processors to enable the one or more processors to perform the features discussed herein. Each of these components may be in communication with one another (e.g., via one or more buses).

Receiver 710 may receive information such as packets, user data, or control information associated with various information channels (e.g., control channels, data channels, and information related to buffer status report triggering, etc.). Information may be passed on to other components of the device. The receiver 710 may be an example of aspects of the transceiver 935 described with reference to FIG. 9.

Communications manager 715 may be an example of aspects of the communications manager 915 described with reference to FIG. 9. Communications manager 715 may also include queue monitor 725 and trigger condition manager 730.

Queue monitor 725 may identify that an amount of uplink data queued in a buffer of a station is less than a predetermined threshold.

Trigger condition manager 730 may determine that a BSR trigger condition is satisfied by estimating that the station has data to transmit to the access point, or by identifying that the access point will schedule an uplink transmission for the station. Trigger condition manager 730 may cause transmission of a BSR trigger to the station based at least in part on identifying that the amount of uplink data queued in the buffer is less than the predetermined threshold and determining that the BSR trigger condition is satisfied. Trigger condition manager 730 may determine that the station lacks data to transmit based at least in part on a BSR received from the station, and add an amount of time to a BSR trigger interval for the station based at least in part on determining that the station lacks data to transmit. In some cases, adding the amount of time to the BSR trigger interval includes adding the amount of time to the BSR trigger interval for each BSR received from the station indicating that the station lacks data to transmit until a maximum BSR trigger interval value is reached.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may include a single antenna, or it may include a set of antennas.

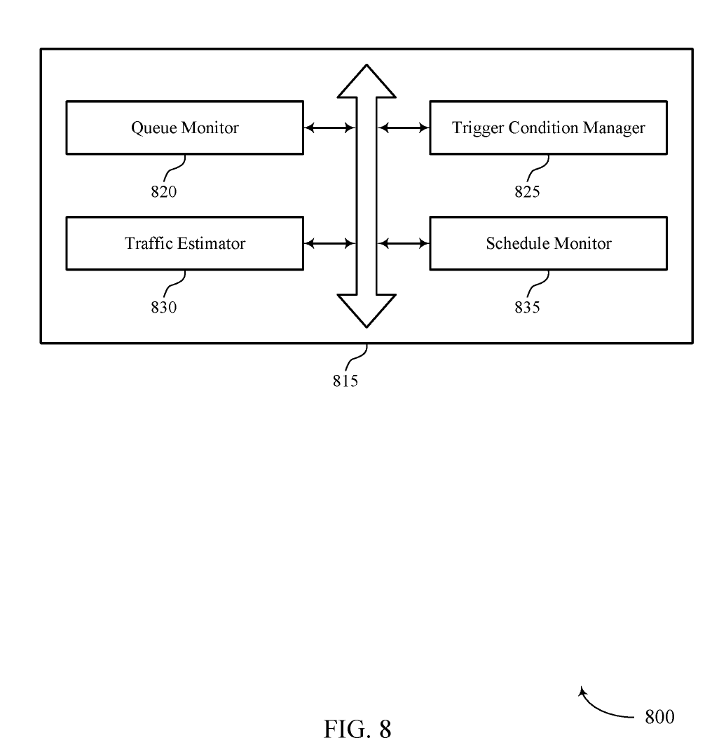

FIG. 8 shows a block diagram 800 of a communications manager 815 that supports buffer status report triggering in accordance with various aspects of the present disclosure. The communications manager 815 may be an example of aspects of a communications manager 615, a communications manager 715, or a communications manager 915 described with reference to FIGS. 6, 7, and 9. The communications manager 815 may include queue monitor 820, trigger condition manager 825, traffic estimator 830, and schedule monitor 835. Each of these modules may communicate, directly or indirectly, with one another (e.g., via one or more buses). In an example, one or more processors (e.g., a transceiver processor, or a radio processor, or a receiver processor, and the like) may implement some or all of the operations of queue monitor 820, trigger condition manager 825, traffic estimator 830, and schedule monitor 835. The one or more processors may be coupled with memory and execute instructions stored in the memory that enable the one or more processor to perform or facilitate the features discussed herein. A transceiver processor may be collocated with and/or communicate with (e.g., direct the operations of) a transceiver of the wireless device 705. A radio processor may be collocated with and/or communicate with (e.g., direct the operations of) a radio (e.g., an LTE radio or a Wi-Fi radio) of the wireless device 705. A receiver processor may be collocated with and/or communicate with (e.g., direct the operations of) a receiver of the wireless device 705.

Queue monitor 820 may identify that an amount of uplink data queued in a buffer of a station is less than a predetermined threshold. In some cases, the queue monitor 820 may be a processor (e.g., a transceiver processor, or a radio processor, or a receiver processor). The processor may be coupled with memory and execute instructions stored in the memory that enable the processor to perform or facilitate the queue monitoring features discussed herein.

Trigger condition manager 825 may determine that a buffer status report (BSR) trigger condition is satisfied by estimating that the station has data to transmit to the access point, or by identifying that the access point will schedule an uplink transmission for the station. Trigger condition manager 825 may cause transmission of a BSR trigger to the station based at least in part on identifying that the amount of uplink data queued in the buffer is less than the predetermined threshold and determining that the BSR trigger condition is satisfied. Trigger condition manager 825 may determine that the station lacks data to transmit based at least in part on a BSR received from the station, and add an amount of time to a BSR trigger interval for the station based at least in part on determining that the station lacks data to transmit. In some cases, adding the amount of time to the BSR trigger interval includes adding the amount of time to the BSR trigger interval for each BSR received from the station indicating that the station lacks data to transmit until a maximum BSR trigger interval value is reached. In some cases, the trigger condition manager 825 may be a processor (e.g., a transceiver processor, or a radio processor, or a receiver processor). The processor may be coupled with memory and execute instructions stored in the memory that enable the processor to perform or facilitate the trigger condition management features discussed herein.

Traffic estimator 830 may estimate that a station has data to transmit to an access point based at least in part on a traffic pattern. In an example, traffic estimator 830 may estimate that the station has data to transmit to the access point is based at least in part on: a type of data traffic identified in a traffic pattern of the station, or a minimum throughput requirement associated with data traffic identified in the traffic pattern, or a delay requirement associated with data traffic identified in the traffic pattern, or a combination thereof. In some cases, traffic estimator 830 may determine that an amount of TCP ACK)s received from the station is below a TCP ACK ratio, and determine that an amount of TCP ACKs transmitted to the station has reached a TCP ACK ratio. In some cases, estimating that the station has data to transmit to the access point includes determining that a predefined amount of TCP data has been transmitted to the station. In some cases, estimating that the station has data to transmit to the access point includes determining that a predefined amount of TCP ACKs have been transmitted to the station. In some cases, estimating that the station has data to transmit to the access point includes determining that a traffic pattern satisfies a sporadic traffic metric. In some cases, the traffic estimator 830 may be a processor (e.g., a transceiver processor, or a radio processor, or a receiver processor). The processor may be coupled with memory and execute instructions stored in the memory that enable the processor to perform or facilitate the traffic estimation features discussed herein.

Schedule monitor 835 may identify a time when the access point will schedule an uplink transmission for the station, where the BSR trigger is transmitted to the station within a predefined time period prior to the identified time. In some cases, identifying that the access point will schedule the uplink transmission for the station includes identifying a quality of service associated with data traffic of the station, determining a scheduling interval for the station based at least in part on the quality of service, and determining a statistical metric of historical scheduling intervals for the station based at least in part on the determined scheduling interval. In some cases, schedule monitor 835 may identify a total number of stations to be scheduled and determine a scheduling interval for the station based at least in part on the total number. In some cases, schedule monitor 835 may be a processor (e.g., a transceiver processor, or a radio processor, or a receiver processor). The processor may be coupled with memory and execute instructions stored in the memory that enable the processor to perform or facilitate the schedule monitoring features discussed herein.

FIG. 9 shows a diagram of a system 900 including a device 905 that supports buffer status report triggering in accordance with various aspects of the present disclosure. Device 905 may be an example of or include the components of wireless device 605, wireless device 705, or an AP 105 as described above, e.g., with reference to FIGS. 1, 6 and 7. Device 905 may include components for bi-directional voice and data communications including components for transmitting and receiving communications, including communications manager 915, processor 920, memory 925, software 930, transceiver 935, antenna 940, and I/O controller 945. These components may be in electronic communication via one or more busses (e.g., bus 910).

Processor 920 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting buffer status report triggering).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware and/or software operation such as the interaction with peripheral components or devices.

Software 930 may include code to implement aspects of the present disclosure, including code to support buffer status report triggering. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system.

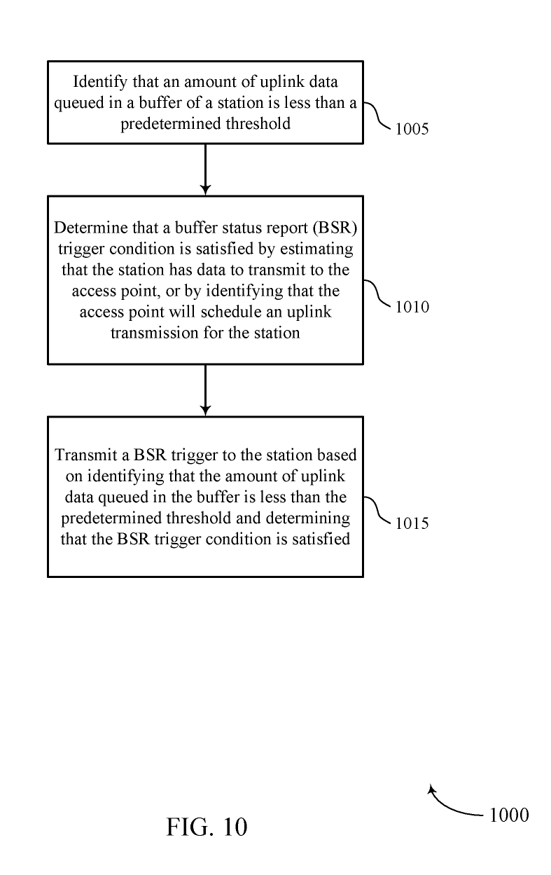

FIG. 10 shows a flowchart illustrating a method 1000 for buffer status report triggering in accordance with various aspects of the present disclosure. The operations of method 1000 may be implemented by an AP 105 or its components as described herein. For example, the operations of method 1000 may be performed by a communications manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

At block 1005 the AP 105 may identify that an amount of uplink data queued in a buffer of a station is less than a predetermined threshold. The operations of block 1005 may be performed according to the methods described with reference to FIGS. 1 through 5. In certain examples, aspects of the operations of block 1005 may be performed by a queue monitor as described with reference to FIGS. 6 through 9.

At block 1010 the AP 105 may determine that a BSR trigger condition is satisfied by estimating that the station has data to transmit to the access point, or by identifying that the access point will schedule an uplink transmission for the station. The operations of block 1010 may be performed according to the methods described with reference to FIGS. 1 through 5. In certain examples, aspects of the operations of block 1010 may be performed by a trigger condition manager as described with reference to FIGS. 6 through 9.

At block 1015 the AP 105 may transmit a BSR trigger to the station based at least in part on identifying that the amount of uplink data queued in the buffer is less than the predetermined threshold and determining that the BSR trigger condition is satisfied. The operations of block 1015 may be performed according to the methods described with reference to FIGS. 1 through 5. In certain examples, aspects of the operations of block 1015 may be performed by a trigger condition manager as described with reference to FIGS. 6 through 9.

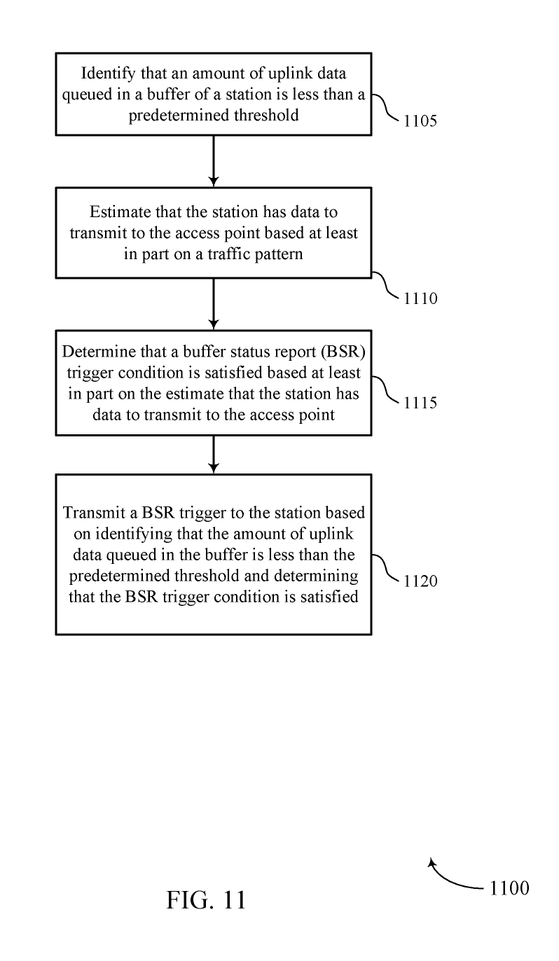

FIG. 11 shows a flowchart illustrating a method 1100 for buffer status report triggering in accordance with various aspects of the present disclosure. The operations of method 1100 may be implemented by an AP 105 or its components as described herein. For example, the operations of method 1100 may be performed by a communications manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

At block 1105 the AP 105 may identify that an amount of uplink data queued in a buffer of a station is less than a predetermined threshold. The operations of block 1105 may be performed according to the methods described with reference to FIGS. 1 through 5. In certain examples, aspects of the operations of block 1105 may be performed by a queue monitor as described with reference to FIGS. 6 through 9.

At block 1110 the AP 105 may estimate that the station has data to transmit to the access point based at least in part on a traffic pattern. The operations of block 1110 may be performed according to the methods described with reference to FIGS. 1 through 5. In certain examples, aspects of the operations of block 1110 may be performed by a traffic estimator as described with reference to FIGS. 6 through 9.

At block 1115 the AP 105 may determine that a buffer status report (BSR) trigger condition is satisfied by based at least in part on the estimate that the station has data to transmit to the access point. The operations of block 1110 may be performed according to the methods described with reference to FIGS. 1 through 5. In certain examples, aspects of the operations of block 1110 may be performed by a trigger condition manager as described with reference to FIGS. 6 through 9.

At block 1120 the AP 105 may transmit a BSR trigger to the station based at least in part on identifying that the amount of uplink data queued in the buffer is less than the predetermined threshold and determining that the BSR trigger condition is satisfied. The operations of block 1120 may be performed according to the methods described with reference to FIGS. 1 through 5. In certain examples, aspects of the operations of block 1120 may be performed by a trigger condition manager as described with reference to FIGS. 6 through 9.

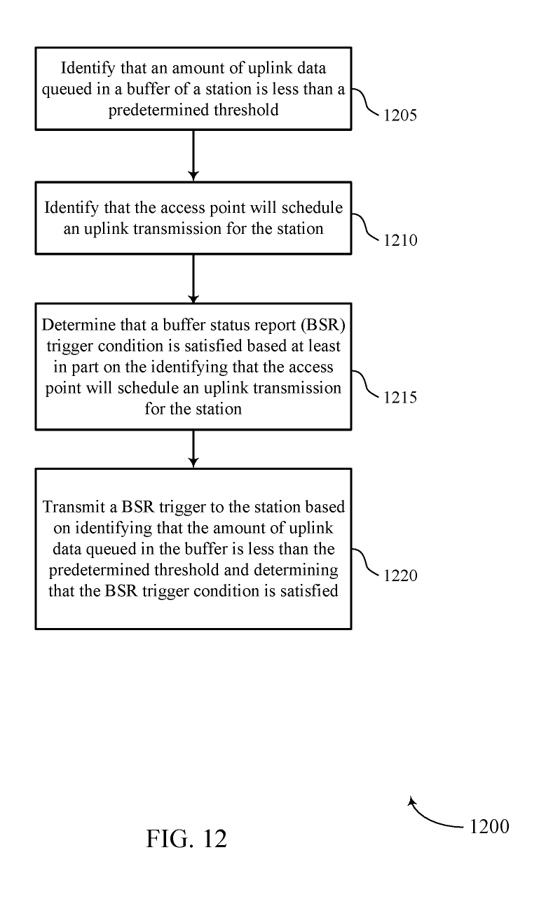

FIG. 12 shows a flowchart illustrating a method 1200 for buffer status report triggering in accordance with various aspects of the present disclosure. The operations of method 1200 may be implemented by an AP 105 or its components as described herein. For example, the operations of method 1200 may be performed by a communications manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

At block 1205 the AP 105 may identify that an amount of uplink data queued in a buffer of a station is less than a predetermined threshold. The operations of block 1205 may be performed according to the methods described with reference to FIGS. 1 through 5. In certain examples, aspects of the operations of block 1205 may be performed by a queue monitor as described with reference to FIGS. 6 through 9.

At block 1210 the AP 105 may identify that the access point will schedule an uplink transmission for the station. The operations of block 1210 may be performed according to the methods described with reference to FIGS. 1 through 5. In certain examples, aspects of the operations of block 1210 may be performed by a schedule monitor as described with reference to FIGS. 6 through 9.

At block 1215 the AP 105 may determine that a BSR trigger condition is satisfied based at least in part on identifying that the access point will schedule an uplink transmission for the station. The operations of block 1210 may be performed according to the methods described with reference to FIGS. 1 through 5. In certain examples, aspects of the operations of block 1210 may be performed by a trigger condition manager as described with reference to FIGS. 6 through 9.

At block 1220 the AP 105 may transmit a BSR trigger to the station based at least in part on identifying that the amount of uplink data queued in the buffer is less than the predetermined threshold and determining that the BSR trigger condition is satisfied. The operations of block 1215 may be performed according to the methods described with reference to FIGS. 1 through 5. In certain examples, aspects of the operations of block 1215 may be performed by a trigger condition manager as described with reference to FIGS. 6 through 9.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication by an access point, comprising:
a memory that stores instructions; and
a processor coupled with the memory, wherein the processor and the memory are configured to:
identify that an amount of uplink data queued in a buffer of a station is less than a predetermined threshold;
determine that a buffer status report (BSR) trigger condition is satisfied by estimating that the station has data to transmit to the access point, or by identifying that the access point will schedule an uplink transmission for the station; and
transmit a BSR trigger to the station based at least in part on identifying that the amount of uplink data queued in the buffer is less than the predetermined threshold and determining that the BSR trigger condition is satisfied.

2. The apparatus of claim 1, wherein the processor and the memory are configured to estimate that the station has data to transmit to the access point by being configured to:
determine a traffic pattern for the station; and
estimate that the station has data to transmit to the access point based at least in part on the determined traffic pattern.

3. The apparatus of claim 1, wherein the processor and the memory are configured to identify that the access point will schedule the uplink transmission for the station by being configured to:
determine a statistical metric of historical scheduling intervals for the station.

4. The apparatus of claim 1, wherein the processor and the memory are further configured to:
identify a time when the access point will schedule an uplink transmission for the station, wherein the BSR trigger is transmitted to the station within a predefined time period prior to the identified time.

5. The apparatus of claim 1, wherein the processor and the memory are further configured to:
determine that the station lacks data to transmit based at least in part on a BSR received from the station; and
add an amount of time to a BSR trigger interval for the station based at least in part on determining that the station lacks data to transmit.

6. The apparatus of claim 5, wherein the processor and the memory are configured to add the amount of time to the BSR trigger interval by being configured to:
add the amount of time to the BSR trigger interval for each BSR received from the station indicating that the station lacks data to transmit until a maximum BSR trigger interval value is reached.

7. The apparatus of claim 1, wherein the processor and the memory are further configured to:
estimate that the station has data to transmit to the access point is based at least in part on:
a type of data traffic identified in a traffic pattern of the station, or
a minimum throughput requirement associated with data traffic identified in the traffic pattern, or
a delay requirement associated with data traffic identified in the traffic pattern, or
a combination thereof.

8. The apparatus of claim 1, wherein the processor and the memory are configured to estimate that the station has data to transmit to the access point by being configured to:
determine that a predefined amount of transmission control protocol (TCP) data has been transmitted to the station; and
determine that an amount of TCP acknowledgments (ACKs) received from the station is below a TCP ACK ratio.

9. The apparatus of claim 1, wherein the processor and the memory are configured to estimate that the station has data to transmit to the access point by being configured to:
determine that a predefined amount of transmission control protocol (TCP) acknowledgments (ACKs) have been transmitted to the station; and
determine that an amount of TCP ACKs transmitted to the station has reached a TCP ACK ratio.

10. The apparatus of claim 1, wherein the processor and the memory are configured to estimate that the station has data to transmit to the access point by being configured to:
determine that a traffic pattern satisfies a sporadic traffic metric.

11. The apparatus of claim 1, wherein the processor and the memory are configured to identify that the access point will schedule the uplink transmission for the station by being configured to:
identify a total number of stations to be scheduled;
determine a scheduling interval for the station based at least in part on the total number; and
determine a statistical metric of historical scheduling intervals for the station based at least in part on the determined scheduling interval.

12. The apparatus of claim 1, wherein the processor and the memory are configured to identify that the access point will schedule the uplink transmission for the station by being configured to:
identify a quality of service associated with data traffic of the station;
determine a scheduling interval for the station based at least in part on the quality of service; and
determine a statistical metric of historical scheduling intervals for the station based at least in part on the determined scheduling interval.

13. The apparatus of claim 1, wherein the apparatus is a wireless communication terminal that comprises an antenna and a transceiver.

14. A method for wireless communication by an access point, comprising:
identifying that an amount of uplink data queued in a buffer of a station is less than a predetermined threshold;
determining that a buffer status report (BSR) trigger condition is satisfied by estimating that the station has data to transmit to the access point, or by identifying that the access point will schedule an uplink transmission for the station; and
transmitting a BSR trigger to the station based at least in part on identifying that the amount of uplink data queued in the buffer is less than the predetermined threshold and determining that the BSR trigger condition is satisfied.

15. The method of claim 14, wherein estimating that the station has data to transmit to the access point comprises:
determining a traffic pattern for the station; and
estimating that the station has data to transmit to the access point based at least in part on the determined traffic pattern.

16. The method of claim 14, wherein identifying that the access point will schedule the uplink transmission for the station comprises:
determining a statistical metric of historical scheduling intervals for the station.

17. The method of claim 14, further comprising:
identifying a time when the access point will schedule an uplink transmission for the station, wherein the BSR trigger is transmitted to the station within a predefined time period prior to the identified time.

18. The method of claim 14, further comprising:
determining that the station lacks data to transmit based at least in part on a BSR received from the station; and
adding an amount of time to a BSR trigger interval for the station based at least in part on determining that the station lacks data to transmit.

19. The method of claim 18, wherein adding the amount of time to the BSR trigger interval comprises:
adding the amount of time to the BSR trigger interval for each BSR received from the station indicating that the station lacks data to transmit until a maximum BSR trigger interval value is reached.

20. The method of claim 14, further comprising:
estimating that the station has data to transmit to the access point is based at least in part on:
a type of data traffic identified in a traffic pattern of the station, or
a minimum throughput requirement associated with data traffic identified in the traffic pattern, or
a delay requirement associated with data traffic identified in the traffic pattern, or
a combination thereof.

21. The method of claim 14, wherein estimating that the station has data to transmit to the access point comprises:
determining that a predefined amount of transmission control protocol (TCP) data has been transmitted to the station; and
determining that an amount of TCP acknowledgments (ACKs) received from the station is below a TCP ACK ratio.

22. The method of claim 14, wherein estimating that the station has data to transmit to the access point comprises:
determining that a predefined amount of transmission control protocol (TCP) acknowledgments (ACKs) have been transmitted to the station; and
determining that an amount of TCP ACKs transmitted to the station has reached a TCP ACK ratio.

23. The method of claim 14, wherein estimating that the station has data to transmit to the access point comprises:
determining that a traffic pattern satisfies a sporadic traffic metric.

24. The method of claim 14, wherein identifying that the access point will schedule the uplink transmission for the station comprises:
identifying a total number of stations to be scheduled;
determining a scheduling interval for the station based at least in part on the total number; and
determining a statistical metric of historical scheduling intervals for the station based at least in part on the determined scheduling interval.

25. The method of claim 14, wherein identifying that the access point will schedule the uplink transmission for the station comprises:
identifying a quality of service associated with data traffic of the station;
determining a scheduling interval for the station based at least in part on the quality of service; and
determining a statistical metric of historical scheduling intervals for the station based at least in part on the determined scheduling interval.

26. An apparatus for wireless communication by an access point, comprising:
means for identifying that an amount of uplink data queued in a buffer of a station is less than a predetermined threshold;
means for determining that a buffer status report (BSR) trigger condition is satisfied by estimating that the station has data to transmit to the access point, or by identifying that the access point will schedule an uplink transmission for the station; and
means for transmitting a BSR trigger to the station based at least in part on identifying that the amount of uplink data queued in the buffer is less than the predetermined threshold and determining that the BSR trigger condition is satisfied.

27. The apparatus of claim 26, wherein the means for determining that the BSR trigger condition is satisfied further comprises:
means for determining a traffic pattern for the station; and
means for estimating that the station has data to transmit to the access point based at least in part on the determined traffic pattern.

28. The apparatus of claim 26, wherein the means for determining that the BSR trigger condition is satisfied further comprises:
means for determining a statistical metric of historical scheduling intervals for the station.

29. The apparatus of claim 26, further comprising:
means for identifying a time when the access point will schedule an uplink transmission for the station, wherein the BSR trigger is transmitted to the station within a predefined time period prior to the identified time.

30. A non-transitory computer readable medium storing code for wireless communication by an access point, the code comprising instructions executable by a processor to:
identify that an amount of uplink data queued in a buffer of a station is less than a predetermined threshold;
determine that a buffer status report (BSR) trigger condition is satisfied by estimating that the station has data to transmit to the access point, or by identifying that the access point will schedule an uplink transmission for the station; and
transmit a BSR trigger to the station based at least in part on identifying that the amount of uplink data queued in the buffer is less than the predetermined threshold and determining that the BSR trigger condition is satisfied.
